(19) United States
(12) Patent Application Publication
(10) Pub. No.: US 2026/0258855 A1
(43) Pub. Date: Sep. 3, 2026

(54) Reduction gear mechanism for a door lock

(71) Applicant: XTHINGS INDUSTRY LLC, Fremont, CA (US)

(72) Inventor: Lingling QIAN, Fremont, CA (US)

(73) Assignee: XTHINGS INDUSTRY LLC, Fremont, CA (US)

(21) Appl. No.: 19/342,494

(22) Filed: Sep. 27, 2025

(51) Int. Cl. F16H 19/08; E05B 47/00; F16H 57/00; F16H 57/02

(52) U.S. Cl. CPC F16H 19/08; E05B 47/0012; E05B 2047/0017; E05B 2047/002; F16H 57/0006; F16H 2057/02034; F16H 2057/02073

(57) ABSTRACT

The present invention relates to the field of smart lock technology, specifically providing a reduction gear mechanism for a door lock. Through rational multi-stage gear arrangement, reduction ratio design, meshing relationship optimization, and gearbox dimensional constraints, the mechanism enables a conventional motor to deliver high-torque output. Power transmission remains smooth without overload, protecting mechanical integrity of transmission components while reducing vibration and abnormal noise. Motor energy consumption avoids excessive burden, and smart lock space requirements are minimized, thereby ensuring efficient long-term operation and lowering maintenance and production costs.

### TECHNICAL FIELD

The present invention relates to the technical field of smart locks, and in particular to a reduction gear mechanism for a door lock.

### BACKGROUND TECHNOLOGY

With the increasing popularity of smart locks, users have become accustomed to unlocking doors via password entry, fingerprint recognition, or facial recognition technology. This requires a power source within the smart lock to drive the unlocking mechanism, typically implemented using a built-in compact motor.

However, due to a small size of a built-in motor, while a high rotational speed is achievable, its torque output is insufficient. Existing smart lock designs incorporate multiple security and intelligent features, where retracting/extending the latch and rotating the lock cylinder must overcome multiple resistances including door frame friction, latch spring force, and even door sinking-induced jamming force. Consequently, the motor's torque proves inadequate for actuation.

Based on the above reasons, the present invention provides a reduction gear mechanism for a door lock. By strategically arranging multi-stage gears within the smart lock's confined space to form a gearbox, a high-speed output from the motor is progressively converted. This not only effectively enhances the torque at the final output gear but also optimizes internal spatial layout. The design reduces required motor power, improves operational stability, ensures smoother gear transmission, minimizes vibration, lowers long-term mechanical wear maintenance costs, extends motor service life, and delivers significant practical benefits.

### SUMMARY OF THE INVENTION

The objective of the present invention is to overcome deficiencies in prior art by providing a reduction gear mechanism for a door lock. Through rational arrangement of multi-stage gears within the smart lock's confined space to form a gearbox, a high-speed output from the motor is progressively converted. This not only effectively enhances the torque at a final output gear but also optimizes internal spatial layout. The design reduces required motor power, improves operational stability, ensures smoother gear transmission, minimizes vibration, lowers long-term mechanical wear maintenance costs, extends motor service life, and delivers significant practical benefits.

To achieve this objective, the reduction gear mechanism comprises a gearbox housing. The gearbox housing accommodates a motor; a first-stage gear is mounted on a rotation shaft of the motor; the first-stage gear meshes with a large gear of a second-stage gear at a reduction ratio of 2-2.5:1; a small gear of the second-stage gear meshes with a large gear of a third-stage gear at a reduction ratio of 2-2.5:1; a small gear of the third-stage gear meshes with a large gear of a fourth-stage gear at a reduction ratio of 2-2.5:1; a small gear of the fourth-stage gear meshes with a large gear of a fifth-stage gear at a reduction ratio of 2-2.5:1; a small gear of the fifth-stage gear meshes with a large gear of a sixth-stage gear at a reduction ratio of 3:1; a small gear of the sixth-stage gear meshes with an output gear at a reduction ratio of 4.6:1; a bottom cover is disposed below the gearbox housing; a transmission shaft penetrating through the bottom cover is connected to a center portion of the output gear; a magnet is mounted on the output gear.

A distance from a top portion of the bottom cover to a bottom portion of the motor is arranged to be 23 mm to 24 mm; a height of the motor is arranged to be 24 mm to 25 mm; a width of an output gear sleeve of the output gear is arranged to be 12 mm to 13 mm.

The first-stage gear and the output gear are configured as single-gear wheels.

The second-stage gear, the third-stage gear, the fourth-stage gear, the fifth-stage gear, and the sixth-stage gear are configured as double-gear wheels, with each comprising a large gear and a small gear.

A transmission lower cylinder is disposed below the output gear sleeve.

A surface profile of the bottom cover corresponds to surface profiles of the gearbox housing, the second-stage gear, the third-stage gear, the fourth-stage gear, the fifth-stage gear, and the sixth-stage gear disposed above the bottom cover.

A position of the magnet on the output gear corresponds to a position of Hall sensors on a transmission mechanism where the transmission shaft is installed, based on detection requirements.

The Hall sensors are distributed on the transmission mechanism at 90-degree intervals relative to each other.

Compared to conventional solutions, the present invention maximizes spatial utilization within the smart lock's reduction gearbox. Through multi-stage gear reduction in a compact space, torque transmission capability of the motor output is enhanced without causing excessive mechanical wear or failure risk to the gears. Torque requirements, gear meshing losses, and motor stability are balanced. Stable, durable, low-cost operation with high adaptability is achieved without increasing smart lock dimensions.

### BRIEF DESCRIPTION OF THE DRAWINGS

FIG. 1 is a schematic diagram of an overall external structure of the present invention.

FIG. 2 is a schematic diagram of the present invention with a bottom cover removed.

FIG. 3 is a top view schematic diagram of the present invention with the bottom cover removed.

FIG. 4 is a top view schematic diagram of internal gears of the present invention.

FIG. 5 is a schematic diagram illustrating a magnet position on internal gears of the present invention.

FIG. 6 is a side view schematic diagram of internal gears of the present invention.

FIG. 7 is a schematic diagram illustrating dimensional annotations of the present invention.

Reference numerals in the accompanying drawings are indicated as below: 1: gearbox housing; 2: bottom cover; 3: transmission shaft; 4: motor; 5: transmission lower cylinder; 6: output gear sleeve; 7: output gear; 8: magnet; 9: first-stage gear; 10: second-stage gear; 11: third-stage gear; 12: fourth-stage gear; 13: fifth-stage gear; 14: sixth-stage gear.

### SPECIFIC EMBODIMENTS

The present invention is further described below with reference to the accompanying drawings.

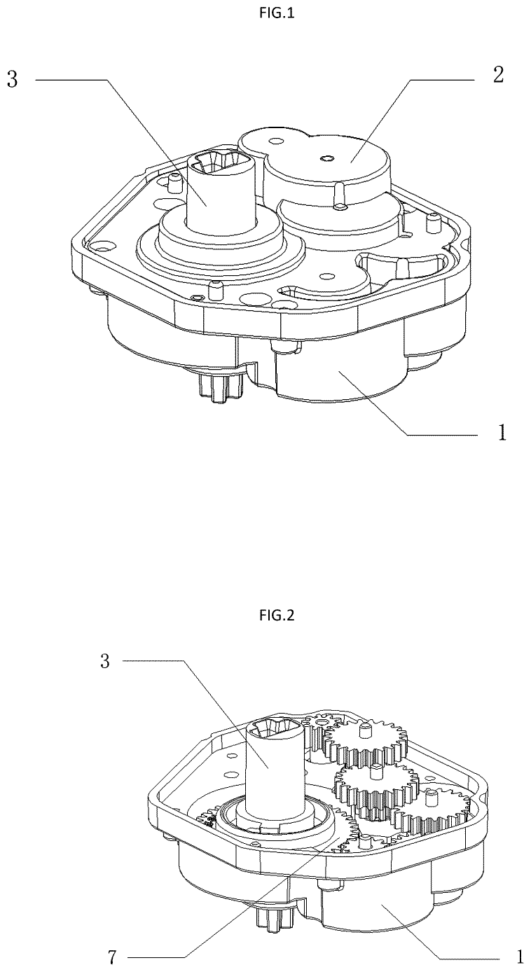

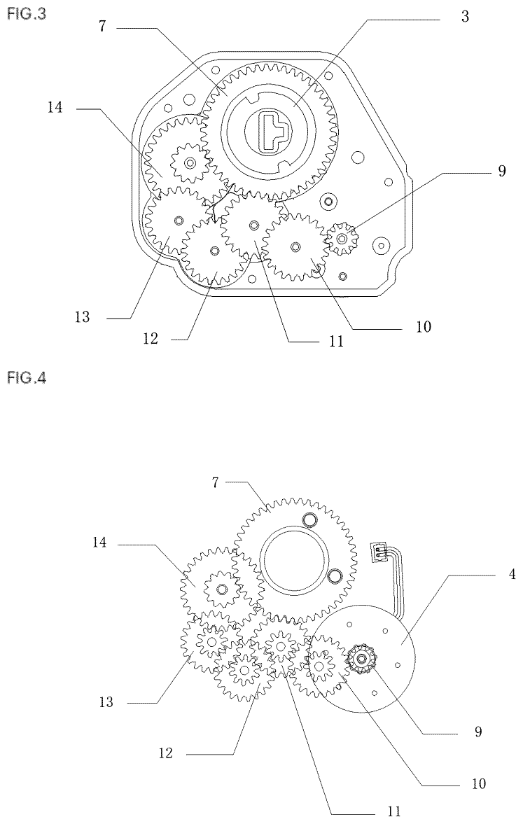

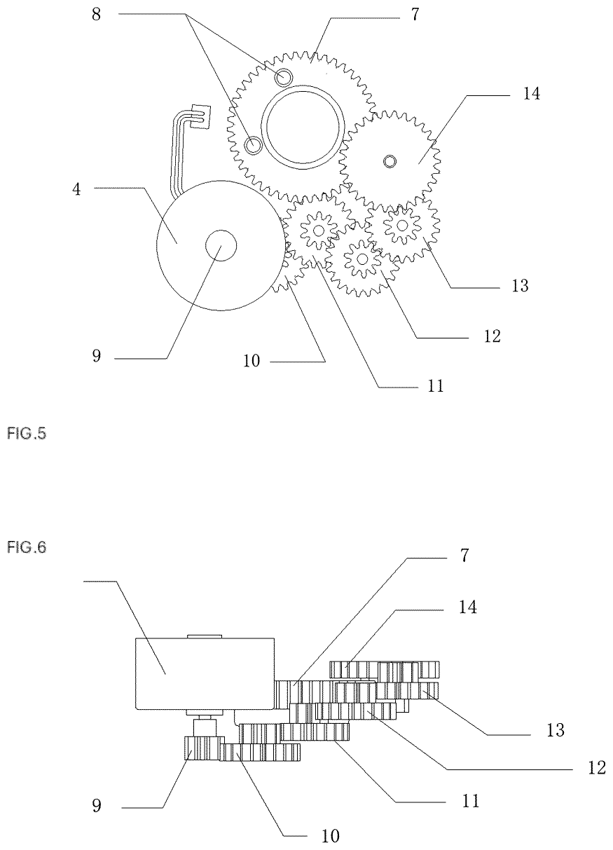

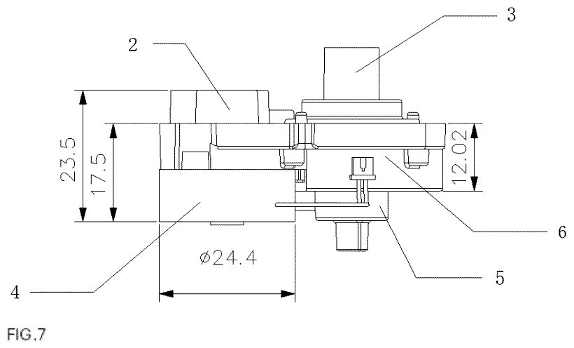

Referring to FIGS. 1-7, the present invention provides a reduction gear mechanism for a door lock comprising a gearbox housing 1. The gearbox housing 1 accommodates a motor 4; a first-stage gear 9 is mounted on a rotation shaft of the motor 4; the first-stage gear 9 meshes with a large gear of a second-stage gear 10 at a reduction ratio of 2-2.5:1; a small gear of the second-stage gear 10 meshes with a large gear of a third-stage gear 11 at a reduction ratio of 2-2.5:1; a small gear of the third-stage gear 11 meshes with a large gear of a fourth-stage gear 12 at a reduction ratio of 2-2.5:1; a small gear of the fourth-stage gear 12 meshes with a large gear of a fifth-stage gear 13 at a reduction ratio of 2-2.5:1; a small gear of the fifth-stage gear 13 meshes with a large gear of a sixth-stage gear 14 at a reduction ratio of 3:1; a small gear of the sixth-stage gear 14 meshes with an output gear 7 at a reduction ratio of 4.6:1; a bottom cover 2 is disposed below the gearbox housing 1. A transmission shaft 3 penetrating through the bottom cover 2 is connected to a center portion of the output gear 7; a magnet 8 is mounted on the output gear 7.

A distance from a top portion of the bottom cover 2 to a bottom portion of the motor 4 is arranged to be 23 mm to 24 mm; a height of the motor 4 is arranged to be 24 mm to 25 mm; a width of an output gear sleeve 6 of the output gear 7 is arranged to be 12 mm to 13 mm.

The first-stage gear 9 and the output gear 7 are configured as single-gear wheels.

The second-stage gear 10, the third-stage gear 11, the fourth-stage gear 12, the fifth-stage gear 13, and the sixth-stage gear 14 are configured as double-gear wheels, with each comprising a large gear and a small gear.

A transmission lower cylinder 5 is disposed below the output gear sleeve 6.

A surface profile of the bottom cover 2 corresponds to surface profiles of the gearbox housing 1, the second-stage gear 10, the third-stage gear 11, the fourth-stage gear 12, the fifth-stage gear 13, and the sixth-stage gear 14 disposed above the bottom cover 2.

A position of the magnet 8 on the output gear 7 corresponds to a position of Hall sensors on a transmission mechanism where the transmission shaft 3 is installed, based on detection requirements.

The Hall sensors are distributed on the transmission mechanism at 90-degree intervals relative to each other.

The above embodiments are merely preferred implementations of the present invention for facilitating understanding of the method and core concepts. The protection scope of the present invention is not limited to these embodiments, but encompasses all technical solutions conceived under the principle of the present invention. It should be noted that modifications and refinements made by those skilled in the art without departing from the principles of the present invention shall fall within the protection scope of the invention.

The present invention comprehensively resolves deficiencies in prior-art smart locks, including excessive motor power consumption due to insufficient torque, severe wear on gears/components during torque amplification, and oversized dimensions from suboptimal layouts. Through rational multi-stage gear arrangement, reduction ratio design, meshing relationship optimization, and gearbox dimensional constraints, conventional motors can achieve high-torque output. Power transmission remains smooth without overload, protecting mechanical integrity of components while reducing vibration and noise. Motor energy consumption is minimized, and smart lock space requirements are reduced. This ensures efficient long-term operation and lowers maintenance/production costs.

What is claimed is:

1. A reduction gear mechanism for a door lock, comprising a gearbox housing (1), wherein: the gearbox housing (1) accommodates a motor (4); a first-stage gear (9) is mounted on a rotation shaft of the motor (4); the first-stage gear (9) meshes with a large gear of a second-stage gear (10) at a reduction ratio of 2-2.5:1; a small gear of the second-stage gear (10) meshes with a large gear of a third-stage gear (11) at a reduction ratio of 2-2.5:1; a small gear of the third-stage gear (11) meshes with a large gear of a fourth-stage gear (12) at a reduction ratio of 2-2.5:1; a small gear of the fourth-stage gear (12) meshes with a large gear of a fifth-stage gear (13) at a reduction ratio of 2-2.5:1; a small gear of the fifth-stage gear (13) meshes with a large gear of a sixth-stage gear (14) at a reduction ratio of 3:1; a small gear of the sixth-stage gear (14) meshes with an output gear (7) at a reduction ratio of 4.6:1; a bottom cover (2) is disposed below the gearbox housing (1); a transmission shaft (3) penetrating through the bottom cover (2) is connected to a center portion of the output gear (7); a magnet (8) is mounted on the output gear (7);
a distance from a top portion of the bottom cover (2) to a bottom portion of the motor (4) is arranged to be 23 mm to 24 mm; a height of the motor (4) is arranged to be 24 mm to 25 mm; a width of an output gear sleeve (6) of the output gear (7) is arranged to be 12 mm to 13 mm.

2. The reduction gear mechanism for a door lock according to claim 1, wherein the first-stage gear (9) and the output gear (7) are configured as single-gear wheels.

3. The reduction gear mechanism for a door lock according to claim 1, wherein the second-stage gear (10), the third-stage gear (11), the fourth-stage gear (12), the fifth-stage gear (13), and the sixth-stage gear (14) are configured as double-gear wheels, with each comprising a large gear and a small gear.

4. The reduction gear mechanism for a door lock according to claim 1, wherein a transmission lower cylinder (5) is disposed below the output gear sleeve (6).

5. The reduction gear mechanism for a door lock according to claim 1, wherein a surface profile of the bottom cover (2) corresponds to surface profiles of the gearbox housing (1), the second-stage gear (10), the third-stage gear (11), the fourth-stage gear (12), the fifth-stage gear (13), and the sixth-stage gear (14) disposed above the bottom cover (2).

6. The reduction gear mechanism for a door lock according to claim 1, wherein a position of the magnet (8) on the output gear (7) corresponds to a position of Hall sensors on a transmission mechanism where the transmission shaft (3) is installed, based on detection requirements.

7. The reduction gear mechanism for a door lock according to claim 1, wherein the Hall sensors are distributed on the transmission mechanism at 90-degree intervals relative to each other.
